(19) United States
(12) Patent Application Publication
(10) Pub. No.: US 2016/0012454 A1
(43) Pub. Date: Jan. 14, 2016

(54) DATABASE SYSTEMS FOR MEASURING IMPACT ON THE INTERNET

(71) Applicant: SALESFORCE.COM, INC., San Francisco, CA (US)

(72) Inventors: Christopher Daniel Newton, Fredericton (CA); Marcel Albert Lebrun, Fredericton (CA); Christopher Bennett Ramsey, Fredericton (CA)

(73) Assignee: SALESFORCE.COM, INC., San Francisco, CA (US)

(21) Appl. No.: 14/849,144

(22) Filed: Sep. 9, 2015

Related U.S. Application Data
(63) Continuation-in-part of application No. 12/333,277, filed on Dec. 11, 2008, now abandoned.
Application No. 12/333,277 is a continuation-in-part of application No. 12/174,345, filed on Jul. 16, 2008.
(60) Provisional application No. 61/013,242, filed on Dec. 12, 2007.
(60) Provisional application No. 60/956,258, filed on Aug. 16, 2007.

(51) Int. Cl. G06Q 30/02; G06Q 50/00; G06F 17/30

(52) U.S. Cl. CPC G06Q 30/0201; G06F 17/30867; G06F 17/30598; G06F 17/30345; G06F 17/30528; G06F 17/3053; G06Q 50/01

(57) ABSTRACT

Database computer systems are provided for determining influence of various categories of content sources on a selected brand. A brand profile using terms and URLs associated with the selected brand is stored in a database. The computer queries popular search engines over the Internet using the terms and URLs from the database as search terms. The results are classified according to their category of content sources and impact values and a brand ownership score are calculated from the classified results and from other weights associated to the ranks of the results, to the category of content sources and to the search engines. The category of content sources having ownership of the selected brand is then identified.

### RELATED APPLICATIONS

This application is a continuation-in-part of U.S. patent application Ser. No. 12/333,277, filed Dec. 11, 2008, which claims the benefit of U.S. Provisional Patent Application Ser. No. 61/013,242, filed Dec. 12, 2007, and U.S. patent application Ser. No. 12/174,345, filed Jul. 16, 2008, which claims the benefit of U.S. Provisional Patent Application Ser. No. 60/956,258, filed Aug. 16, 2007.

### TECHNICAL FIELD

Embodiments of the subject matter described herein relate generally to computer systems, and more particularly, to database computer systems and methods for determining influence of various categories of media, and in particular, social media on a corporate brand.

### BACKGROUND

The rise of social media, for example, socially connected consumer generated media, has affected how brands are perceived and how marketers and brand owners work with the brand. The perception of a brand by consumers was once in the control of brand owners, and largely the result of marketing and advertising campaigns. Those days are gone now as people move away from traditional media sources such as TV, newspapers and magazines. Further, the entire generation of youth, referred to as digital natives, has been raised, who have been growing up with the Internet and digital devices and content on demand, and having almost no connection to newspapers, magazines and limited use of television. For these people, the image of a brand in their mind is almost completely formed by what they see online. Specifically, search engines play a key role in this regard.

When a user looks for information on a brand or product online they will use search engines. Depending on what communities and interests the user has, they may use a variety of search engines, which cover various segments of content. For instance, they may use Blog search engines to find content from bloggers about the product. They may use the search abilities on their favorite video content provider, such as YouTube, to look for user reviews of the product. They may search Flickr or other similar image search engines to find product pictures by people who have bought them. They may also use Google search, Yahoo and other search engines to find text reviews.

In every case, the order of search results returned to the user has a profound effect on the user's view of a brand. It is widely known that the percentage of users who proceed to click through past the first few pages of search results obtained from a search engine is very small. Because of this, the search results returned in those first few pages are critical to the formation of a brand in the eyes of a user.

Importantly then, it is clear that the one who owns the search results returned on the first few pages across most popular search engines is largely in control of the brand. This fact has been known to the experts in the field of brand management and public relations (PR), and has been discussed openly in recent years.

However, it has been unknown how to measure the breakdown of brand ownership for individual clients.

If mainstream media links dominate in the search results returned by search engines for a particular brand, then that brand can be considered to be ‘owned’ by mainstream media. If the search results return by search engines are largely related to press releases, links or websites of the brand owner, then the brand owner owns the voice of the brand on the Internet.

If, however, the search results returned by search engines are largely represented by community driven sites and social media content, then the brand can be considered to be owned by the community. In this case, the brand heavily depends on views and content generated by consumers and not the company, which owns the brand, and not by mainstream media. Therefore the social media for this brand becomes a very important component for the brand.

Search engine optimization companies and reputation management companies have been offering certain classifications of the search results by using sentiment analysis of the results to determine if they are positive or negative for the brand. However, it does not categorize or measure the extent to which others own the brand.

Accordingly, there is a need in the industry for the development of methods and system for determining a measure of the impact of the social media on a brand as a whole.

Determining on-line influence of a commentor, an individual or an entity, in social media sites has also become an increasingly important subject nowadays. A major problem facing marketers and public relations (PR) professionals revolves around the prolific use of social media sites and the awesome scale they have achieved. Literally hundreds of thousands of videos, blog posts, podcasts, events, and social network interactions, such as wall posts, group postings, and others, occur daily. Due to the sheer volume of content, constantly changing landscape of popular sites, and hundreds of millions of users involved, it is impossible to determine who should be listened to and those who must be engaged.

Existing systems for determining influence in social media are site based, i.e. their models of influence are calculated on a per-site basis. If there is a one-to-one relationship from a site to a person (an author), then the influence is extrapolated to indicate the person's influence for the medium in which the site exists. For instance, if siteA is a blog with only one author, and all blogs are counted similarly, then the influence for the siteA as calculated by the prior art methods would also indicate the influence for the author of the blog.

Prior art methods predominantly calculate influence in social media by recursively analyzing inbound web page link counts. For example, siteA would have a higher influence score then siteB if the following approximate rules apply:

RULE 1. If siteA has more links pointing at it, then siteB has linking to it.

RULE 2. If the sites pointing at siteA have a higher count of sites pointing at them, then the count of sites that are pointing at the sites that point at siteB.

Rule 2 is applied recursively.

Various issues exist with the prior art methods, namely: the methods assume the total influence of the sites can be measured by a single property and that no other factors affect influence to a scale large enough to invalidate using only inbound link count as the measured property; the methods assume that the picture painted by the link graph is complete enough to be a proxy for influence; the methods assume that a link implies that the linker has been influenced by the site he is linking to, which is not necessarily the case; the methods do not account for connections someone may have with a site, if there is no link to track that connection, i.e. if a visitor does not own a blog, and therefore does not link out to anyone, but he is still a frequent visitor to the blog, e.g., http://www.autoblog.com, then the influence that Autoblog has over the visitor is not calculated; and the methods do not map properly to other types of content and methods of social media expression, e.g., link-analysis methods deployed to the blogosphere are not relevant in the micromedia sphere of Twitter, i.e. link analysis techniques do not translate to all forms of social media and therefore they leave out entire pools of influencers that use other media channels as their voice.

US Published patent application 2007/0214097 to Parsons et al. and entitled “SOCIAL ANALYTICS SYSTEM AND METHOD FOR ANALYZING CONVERSATIONS IN SOCIAL MEDIA” discloses a conversation monitoring and analysis method to identify influencers. This prior art publication monitors an on going conversation in social media and extract properties of documents for the conversation such as page popularity, site popularity, relevance, recency, and others. The influence is then computed for all the documents and corresponding publishers, whereby the most influential publishers are being identified. However, this prior art method uses a limited number of parameters to determining the influence of a publisher, which therefore affects the accuracy of the influence score.

Accordingly, there is a need in the industry for developing alternative and improved methods and system for determining on-line influence of entities publishing content in social media outlets or sites as well as for determining the influence of social media outlets hosting the content.

### BRIEF DESCRIPTION OF THE DRAWINGS

Embodiments of the invention will now be described, by way of example, with reference to the accompanying drawings, in which:

FIG. 1 shows a block diagram illustrating a brand ownership determination system according to the embodiment of the present invention;

FIG. 2 shows a block diagram of a brand ownership scoring module of FIG. 1;

FIG. 3 shows a flowchart illustrating a method for determining a brand ownership score;

FIG. 4 shows a table illustrating classified search results for a first entry;

FIG. 5 shows a table illustrating classified search results for a second entry;

FIG. 6 shows a table illustrating an assignment of rank weights to search results;

FIG. 7 illustrates a system architecture, in which the embodiments of the present invention have been implemented;

FIG. 8 illustrates different social media outlets that can be used with the present invention;

FIG. 9 illustrates a Content-to-Topic Matching block of the system of FIG. 7;

FIG. 10 shows a flowchart illustrating the operation of the Content-to-Topic Matching block of FIG. 9;

FIG. 11 shows a block diagram for a system for determining a topical on-line influence of an entity according to the embodiment of the invention;

FIG. 12 illustrates viral properties for various social media outlets;

FIG. 13 shows a flowchart illustrating the operation of the system of FIG. 11;

FIG. 14 illustrates a user interface for adjusting the weights in the influence calculation model;

FIG. 15 illustrates a user interface representation of calculated influence measures for origin sites around a given topic; and

FIG. 16 illustrates a user interface showing top movers and top influencers for a given topic.

### DETAILED DESCRIPTION

Accordingly, there is an object of this invention to provide a method and system, which would allow companies to measure and understand the impact social media, or other categories of media owners or content sources, on their brands. With this measure, a company can assess the impact and trend, which social media has on the brand, and determine what possible business outcomes stem from this.

### Brand Ownership Score Summary

The method and system of the embodiment of the present invention provide a measure, which can gauge the distribution of content and how it changes over time to determine how the search results across popular search engines are distributed in the following categories of content sources or groups: mainstream media content (or mainstream media owned); brand-owned content; social media or community-owned content; spam content; third party content (or third party owned).

The higher the percentage of content, which is classified as ‘Community Owned’, the more the image of the brand is owned by the community, and the less that brand is in control. It is important or companies to understand this distribution and have a solid measure with which to gauge changes in the brand's ownership.

The first step in generating the Brand Ownership Score is for the customer to define a list of words and phrases that are the core names of the brand or trademarks of the brand. This list is called the Brand Profile.

In addition to words and phrases that need to be added to the Brand Profile, the customer also needs to define online properties that it owns and that are related to the brand. Defining these properties entails adding the URLs that are owned by the company to the Brand Profile.

To generate the measure of Brand Ownership, a method of the embodiment of the invention programmatically interfaces with a number of popular internet search engines. The method then automatically queries each engine with the words and phrases from the Brand Profile.

As the results are returned for each of the entries in the Brand Profile, the method then classifies the first N search results, e.g., first 1000 search results, sorted by relevance and first 1000 results sorted by date, that come back from popular search engines as belonging to one of the following categories: brand owned content; mainstream media owned content; community owned content (social media); spam owned; and third-party owned. Classification of the results is performed by comparing the search results against a number of internal and third party sources.

Brand owned content is classified as such by comparing the results to the list of brand owned sites as entered in the Brand Profile by the customer.

Mainstream media search results are determined by comparing them to an aggregate list of online mainstream media news outlets that is maintained by a third party.

Community owned content (social media) results are determined by comparing the search results to lists generated by an automated social media monitoring service.

Spam owned results are determined by classifying the search results with commercially available spam filters.

Any remaining search results that are not classified into brand owned, mainstream media owned, community owned or spam owned are classified as third-party owned.

As part of determining an overall score/measure of the Brand Ownership, each category as described above has a weight associated with it. The weight scale is from 0.00 to 1.0. Optionally, a user may alter the weights to best fit the importance of the categories to their line of business.

The overall score/measure of the Brand Ownership is then determined by the following equation: SUM all engines [(BrandWeight*(#BrandOwned/1000)*100)+(WeightMainstream*(#MainstreamOwned/1000)*100)+(WeightSocialMedia* (#SociallyOwned/1000)*100)+(WeightSpam*(#SpamOwned/1000)*100)+(WeightThirdParty*(#ThirdPartyOwned/1000)*100)]*100/NumberOfSearchEngines.

The following illustrates an example of this equation, used against one engine:

[Brand Weight 10%*Brand Owned 5%+Mainstream Weight 20%* Mainstream Owned 15%+Social Media Weight 60%* Social Media Owned 70%+Spam Weight 5%* Spam Owned 2%+Third Party Weight 5%* Third Party Owned 8%]*100/Number of Engines=1]=[0.005+0.03+0.42+0.001+0.004]* 100/1=0.46* 100/1

### Brand Ownership Score=46

In the above noted example, category weights were picked without focus to determining the impact of social media on a brand. To understand the impact of social media on a brand, the owner of the brand needs to determine a score which would largely indicate a predominantly social media owned reality. In this case, the following weights may be selected: [Brand Weight 0%*Brand Owned 5%+Mainstream Weight 0%*Mainstream Owned 15%+Social Media Weight 100%*Social Media Owned 70%+Spam Weight 0%*Spam Owned 2%+Third Party Weight 0%*Third Party Owned 8%]*100/Number of Engines=1]=[0+0+0.7+0+0]* 100/1=70

That is, the Brand Ownership Score=70, which means that 70% of the content out there about this brand is social owned.

Each measured result is stored in a time series data store, allowing for trending to be performed that can chart out if more control is moving to communities for a particular brand, or if that control is moving to others, such as mainstream media.

The corresponding system for determining the impact of social media on a corporate brand comprises a general purpose computer having a processing module and a memory for storing instructions for performing the steps of the method as described above and including corresponding functional blocks for performing respective operations.

The embodiments of the present invention provide numerous advantages, most importantly, allowing public relations professionals to make preemptive marketing decisions that are not available today. Thus, an improved method and system for determining a measure of various categories of media owners, e.g., social media, on a corporate brand have been provided.

In one aspect of the present invention, a method for determining a brand ownership is disclosed. The method comprises: (a) generating a brand profile having one or more entries associated with the brand; (b) querying one or more search engines with the one or more entries; (c) retrieving a predetermined number of search results from each of said one or more search engines queried; (d) classifying the search results by assigning each result to a category of content sources; and (e) determining a brand ownership score of the selected brand based on said classified results.

Additionally, the step of generating the brand profile comprises: i) generating a list of terms associated with said brand; ii) generating a list of content sources associated with said brand; and iii) storing the list of terms and the list of content sources in a database.

The step of calculating the brand ownership score further comprises representing the brand ownership score as an array of values, each value corresponding to an impact of a respective category of content sources on the brand.

In a modification to the method, the impact of the respective category of content sources is determined by: i) assigning a weight to the respective category of content sources; ii) calculating a number of search results classified under the respective category of content sources; and iii) determining the impact based on the assigned weight, a number of search results classified under the respective category of content sources, a total number of search engines queried, and a total number of entries in the brand profile.

In another modification to the method, the impact of the respective category of content sources is determined by: i) assigning a weight to the respective category of content sources; ii) assigning a rank weight to each search result, classified under the respective category of content sources, the rank weight corresponding to a rank of the result; and iii) determining the impact based on the assigned weight, the assigned rank weights, a total number of search engines queried, and a total number of entries in the brand profile.

In a further modification to the method, the impact of the respective category of content sources is determined by: i) assigning a weight to the respective category of content sources; ii) assigning a rank weight to each search result, classified under the respective category of content sources, the rank weight corresponding to a rank of the result; iii) assigning a weight to each of said one or more search engines; and iv) determining the impact based on the assigned weight, the assigned rank weights, a total number of search engines queried, a total number of entries in the brand profile, and the assigned weights of the one or more search engines.

Furthermore, the method further comprises identifying the category of content sources having ownership of the selected brand as the category of content sources having a highest value of the impact in the array of values.

Advantageously, the category of content source is selected from the group consisting of: mainstream media content category, spam content category, social media content category, third-party content category and brand content category.

In another aspect of the invention, a method of determining a brand ownership of a brand is provided, the method comprising: (a) providing a brand profile for the brand, wherein the brand profile has one or more entries representing terms and content sources associated with the brand; (b) querying one or more search engines with the one or more entries; (c) for each of said one or more search engines queried, retrieving a predetermined number of search results, and classifying each search result under a category of content sources selected from the group consisting of: mainstream media content category, spam content category, social media content category, third-party content category and brand content category; and (d) determining an impact value of each category of content sources on the selected brand based on a number of results classified under each respective category of content sources.

The method further comprises the step of identifying one category of content sources having a highest impact value as having ownership of the selected brand.

Additionally, the step (d) comprises: i) assigning a weight to each category of content sources; and ii) calculating the impact value based on the assigned weight, the number of search results classified under the respective category of content sources, a total number of search engines queried, and a total number of entries in the brand profile.

In a modification to the method, the step (d) comprises: i) assigning a weight to the respective category of content sources; ii) assigning a rank weight to each search result classified under the respective category of content sources, the rank weight corresponding to the rank of the search result; and iii) calculating the impact value based on the assigned weight, the assigned rank weights, a total number of search engines queried, and a total number of entries in the brand profile.

In another modification to the method, the step (d) comprises: i) assigning a weight to the respective category of content sources; ii) assigning a rank weight to each search result classified under the respective category of content sources, the rank weight corresponding to the rank of the search result; iii) assigning a weight to each of said one or more search engines; and iv) calculating the impact value based on the assigned weight, the assigned rank weights, a total number of search engines queried, a total number of entries in the brand profile, and the assigned weights of the one or more search engines.

In yet another aspect of the present invention, a system for determining a brand ownership is disclosed, the system comprising: a database, stored in a computer readable storage medium, for storing a profile of a brand, the database having one or more entries associated with the brand; a computer, having a processor and a computer readable storage medium storing computer readable instructions for execution by the processor, to form the following modules: a search engine interface for launching searches to one or more search engines using the one or more entries as search terms and retrieving search results returned by the one or more search engines; a classification engine for classifying the search results retrieved by the search engine interface into a category of content sources; and a brand ownership score calculation engine for determining a brand ownership score and identifying a category of content sources as having ownership of the brand based on the brand ownership score.

Advantageously, each search result is classified under a category of content sources selected from the group consisting of: mainstream media content category, spam content category, social media content category, third-party content category and brand content category.

Additionally, the one or more entries of the database comprise a list of one or more terms associated with the selected brand, and a list of one or more content sources associated with the selected brand.

In a modification of the system, the brand ownership score is an array of impact values, each impact value corresponding to a measure of impact of a respective category of content sources.

In a further modification to the system, each impact value of the respective category of content sources is calculated based on a weight associated to the respective category of content sources, and on a number of search results classified under the respective category of content sources.

In another modification to the system, each impact value of the respective category of content sources is calculated based on a weight associated to the respective category of content sources, on a number of search results classified under the respective category of content sources, and on respective rank weights assigned to each of said search results.

In yet another modification to the system, each impact value of the respective category of content sources is calculated based on a weight associated to said respective category of content sources, on a number of search results classified under the respective category of content sources, on respective rank weights assigned to each of said search results, and on respective weights assigned to said one or more search engines.

In yet a further aspect of the present invention, there is disclosed a computer readable medium, comprising a computer code instructions stored thereon, which, when executed by a computer, perform the steps of the methods of the embodiments of the present invention.

### Brand Ownership Score Details

The method and system of the embodiment of the present invention provide a measure that can gauge the distribution of content among categories of content sources and track its changes over time to determine how the search results across popular search engines are distributed amongst the categories of content sources.

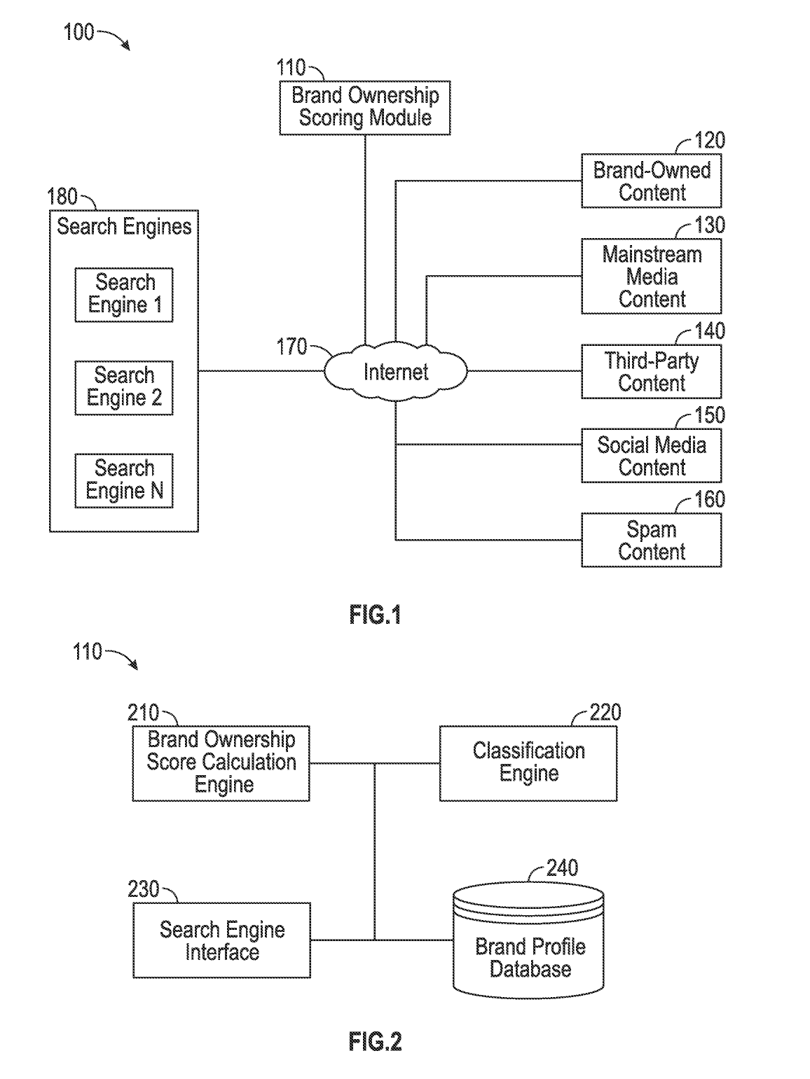

FIG. 1 shows a system of the embodiment of the present invention, comprising a Brand Ownership Scoring Module 110, which is interconnected through a network, such as the Internet 170, to a set of search engines 180 and to different categories of content sources 120 to 160.

The categories of content sources include Brand-owned content 120, Mainstream media content 130, Third-Party content 140, Social Media content 150 and Spam content 160.

The Brand-owned content 120 represents the content originating from online properties, such as websites maintained or owned by the organization or company, to which the brand is registered.

The Mainstream media content 130 represents the content originating from mainstream media news producers such as “New York Times”, “La Gazette”, “La Presse”, “Canadian Broadcasting Corporation” and any other video-based, text-based and audio-based online news producers. In the embodiment of the present invention, an aggregate list of online mainstream media news outlets maintained by a third party is accessible by the Brand Ownership Scoring Module 110.

The Social media content 150 represents the content from online communities, such as blogs, forums, and social networking sites, e.g., Facebook, Flickr, Classmates.com, etc. A social media monitoring service can maintain and update lists of social media sites, which can be accessible by the Brand Ownership Scoring Module 110.

The Spam content 160 represents the content tagged as spam, for example, this type of content can be identified by commercially available spam filters. In the embodiment of the present invention, the Brand Ownership Scoring Module 110 has access to a list of content or sites tagged as spam.

The Third-Party content 140 includes any remaining content, which has not been categorized into Brand owned content 120, Mainstream media content 140, Social media content 150 or Spam content 160.

The set of search engines 180 (Search Engine 1, Search Engine 2, . . . , Search Engine N) includes popular search engines, such as Yahoo, Google, Live Search, Altavista, etc. These search engines are well known to the average Internet user.

In the embodiment of the present invention, the Brand Ownership Scoring module 110 calculates a brand ownership score to determine which category of content sources has more impact on the brand, i.e. owns the brand.

A block diagram of the Brand Ownership Scoring Module 110 is shown in FIG. 2, and will now be described in more detail.

As shown in FIG. 2, the Brand Ownership Scoring Module 110 includes a Brand Profile database 240 for storing profiles of selected brands, the Brand Profile database 240 comprising entries including computer readable instructions stored in a computer readable storage medium, e.g., hard drive, CR-ROM, DVD, non-volatile memory or another type of memory. A Brand Profile (BP) includes one or more entries, which define or are closely associated with a selected brand. The entries include terms, such as words and phrases, which include core names of the brand or trademarks of the brand.

In addition to words and phrases, the entries in the BP can include online properties that are owned by the organization or company, to which the brand is registered, and that are related to the brand. Defining these online properties entails adding the URLs (Uniform Resource Locators) that are owned by the company to the Brand Profile database 240.

The Brand Profile database 240 can be any commercial off-the shelf or proprietary database, which can be used to store profiles of selected brands.

A Search Engine Interface Unit 230 of the Brand Ownership Scoring Module 110 provides the interface to the set of search engines 180, to query the set of search engines 180 with the entries from the BP database 240, and to retrieve search results returned by the set of search engines 180. The search results are generally ranked according to some relevancy criteria defined in each search engine. Each search result has an origin site that can be associated with one of the categories of content sources as described above. Conveniently, the Search Engine Interface Unit 230 comprises computer readable instructions stored in a computer readable medium, which, when executed, cause a processor of a computer to perform various functions of the Search Engine interface Unit 230 as described above.

A Classification Engine 220 of the Brand Ownership Scoring Module 110 receives the search results retrieved by the Search Engine Interface 230 and classifies them according to their origin sites. The classification is performed by comparing the origin sites of the search results against the categories of content sources, and assigning each search result to a respective category of content sources. Conveniently, the Classification Engine 220 comprises a computer readable instructions stored in a computer readable medium, which, when executed, cause a processor of a computer to perform the classification of the search results as described above.

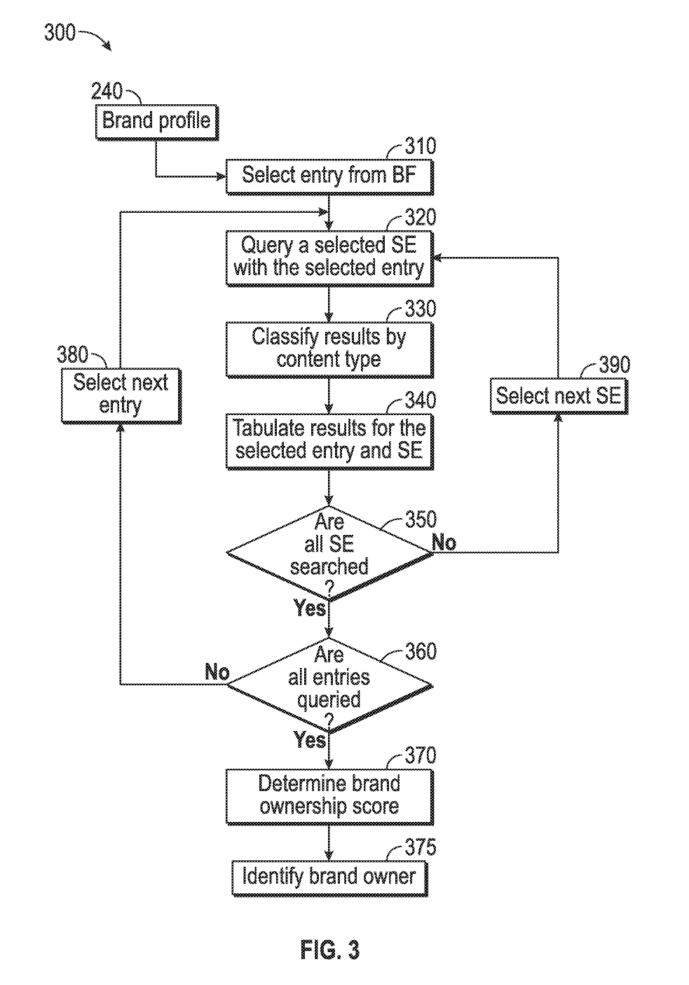

The Brand Ownership Score Calculation Engine 210 of the Brand Ownership Scoring Module 110 shown FIG. 2 applies a calculation method on the search results thus classified to determine a brand ownership score and the category of content sources having more impact on the selected brand. Conveniently, the Brand Ownership Score Calculation Engine 210 comprises computer readable instructions stored in a computer readable medium, which, when executed, cause a processor of a computer to apply a calculation method to the classified search results. Different calculation methods used by the Brand Ownership Score Calculation Engine 210 will be further detailed below with reference to FIG. 3.

As mentioned above, the Brand Ownership Scoring Module 110 can be implemented in one or more software modules comprising computer readable instructions stored in a computer readable storage medium and running on a hardware platform, for example, a general purpose or specialized computer, including a central processing unit (CPU), and a computer readable storage medium, e.g., a memory and other storage devices such as CD-ROM, DVD, hard disk drive, etc.

FIG. 3 shows a flowchart 300 illustrating a method for generating a measure of brand ownership and identifying a brand owner.

At step 310 of the flowchart 300, the method selects a first entry from the Brand Profile database 240, and then queries, at step 320, a selected search engine (SE) with the selected entry. At step 330, the search results are classified according to their origin site under corresponding category of content sources, i.e. as belonging to one of the following categories of content sources:

Brand-owned content 120;

Mainstream media content 130;

Social media content 150;

Spam content 160; and

Third-party content 140.

In one embodiment of the present invention, only the first L search results are considered. By way of example only and for the purpose of simplifying further explanations, L=10 will be considered for the rest of this application. The first 10 search results generally coincide, in most popular search engines, with the first page of the search results. Other values of L could very well be considered without departing from the principles of the present invention.

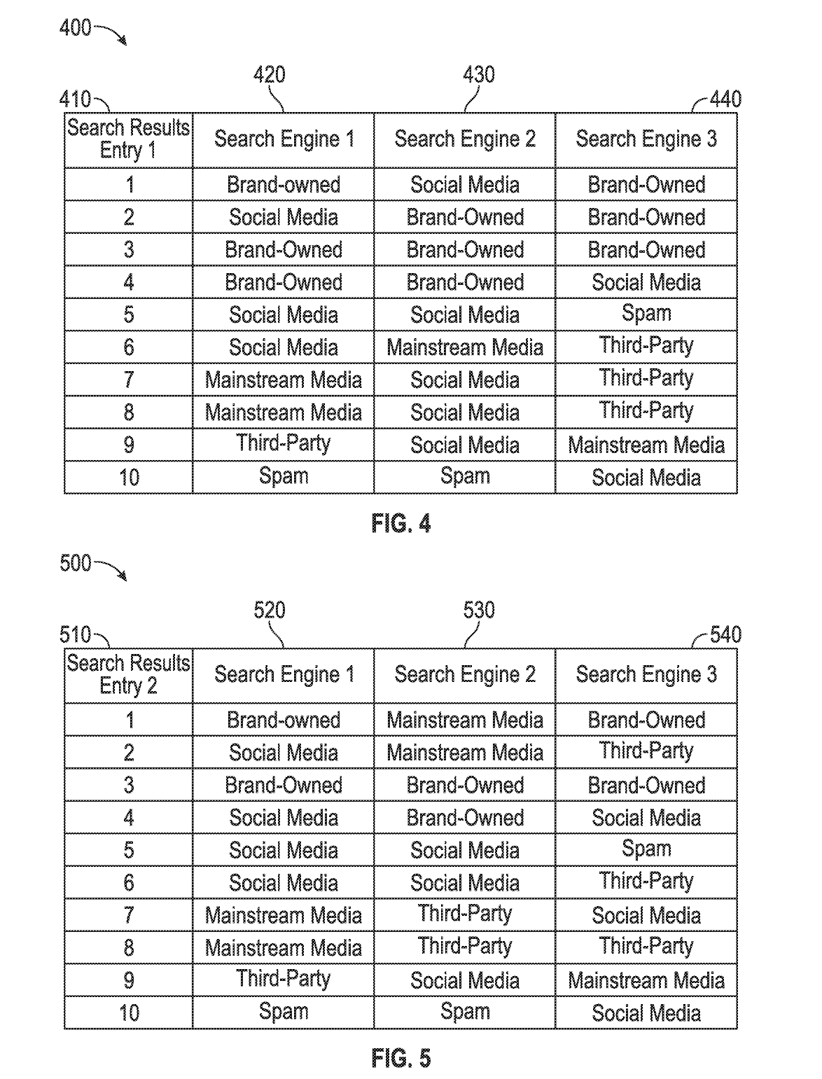

At step 340 of the flowchart 300, the search results thus classified are tabulated as shown in columns 410 and 420 of FIG. 4. Columns 410 and 420 show an exemplary set of results provided by the Search Engine 1, with Column 410 illustrating the search results for the Entry 1, and Column 420 illustrating the categories of content sources assigned to each search result returned by the Search Engine 1. Once the classified search results are tabulated, a check is performed to verify, at step 350, whether all Search Engines have been queried with the selected entry. If the result is NO (exit “No” from step 350), the next search engine is selected, at step 390. The selected entry is now used as a search term to query the newly selected search engine. Steps 320 to 350 are iterated until all search engines have been queried (exit YES from step 350). By way of example only, three search engines have been selected, and at the end of the iteration, the tabulated and classified search results are illustrated in the table 400 of FIG. 4 with regard to the three selected search engines. It is understood that another number of selected search engines may chosen as required.

At step 360, a test is performed to verify whether all entries have been used to search the search engines. If No (exit “No” from step 360), the next entry in the Brand Profile database 240 is selected at step 380, and steps 320 to 350 are repeated with the selected entry as the new search term for all the search engines.

If all entries have been queried (exit “Yes” from step 360), step 370 is invoked to determine the brand ownership score, and at step 375 the category of content sources having ownership of the selected brand is identified, thus completing the method 300.

At the output of step 360, an exemplary classified search results for the second entry (considering only 2 entries in the Brand Profile database 240) is shown in table 500 of FIG. 5.

In the embodiments of the present invention, the brand ownership score determination of step 370, which is performed by the Brand Ownership Score Calculation Engine 210 of the Brand Ownership Scoring Module 110 can calculate the brand ownership score using different methods of calculation.

According to one method, the brand ownership score is expressed as an array of values, each representing a measure of impact of a category of content sources on the selected brand. Each category of content sources has a weight associated with it. Conveniently, the weight scale is from 0.00 to 1.0. Optionally, a user may alter the weights to best fit the importance of the categories of content, e.g., in accordance with the importance of lines of business of the user.

In this method of calculation, the impact for each category is calculated across all N search engines for the total number of entries (TotalNumberOfEntries) searched as follow:

Impact_Brand_Owned=[WeightBrand*100/(10*N)]*(#BrandOwned SE_1+ . . . +#BrandOwned_SE_N)/TotalNumberOfEntries;

with #BrandOwned_SE_K representing the number of search results from the Kth search engine classified as Brand-owned content and WeightBrand is the weight assigned to the category Brand-owned content;

Impact_Mainstream=[WeightMainstream*100/(10*N)]*(#MainstreamOwned_SE_1++#MainstreamOwned_SE_1)/TotalNumberOfEntries;

with #MainstreamOwned_SE_K representing the number of search results from the Kth search engine classified as Mainstream media content and WeightMainstream is the weight assigned to the category Mainstream media content;

Impact_SocialMedia=[WeightSocialMedia*100/(10*N)]*(#SociallyOwned_SE_1++SociallyOwned_SE_N)/TotalNumberOfEntries;

with #SociallyOwned_SE_K representing the number of search results from the Kth search engine classified as Social media content and WeightSocialMedia is the weight assigned to the category Social Media content;

Impact_Spam=[WeightSpam*100/(10*N)]*(#SpamOwned_SE_1+ . . . +#SpamOwned_SE_N) /TotalNumberOfEntries;

with #SpamOwned_SE_K representing the number of search results from the Kth search engine classified as Spam content and WeightSpam is the weight assigned to the category Spam content;

Impact_ThirdParty=[WeightThirdParty*100/(10*N)]*(#ThirdPartyOwned_SE_1+ . . . +#ThirdPartyOwned_SE_1)/TotalNumberOfEntries

with #ThirdPartyOwned_SE_K representing the number of search results from the Kth search engine classified as Third Party content and WeightThirdParty is the weight assigned to the category Third-party content.

In this method of calculation, the step 375 of the flowchart 300 can readily identify the category of content sources, which has the ownership of the selected brand (Brand_Owner) by identifying the category of content sources with the highest value in the array representation of the brand ownership score i.e. Brand_Owner is the category corresponding to the

max (Impact_Brand_Owned, Impact_Mainstream, Impact_SocialMedia, Impact_Spam, Impact_ThirdParty);

with max( ) being the mathematical function that returns the element with the highest value in the argument.

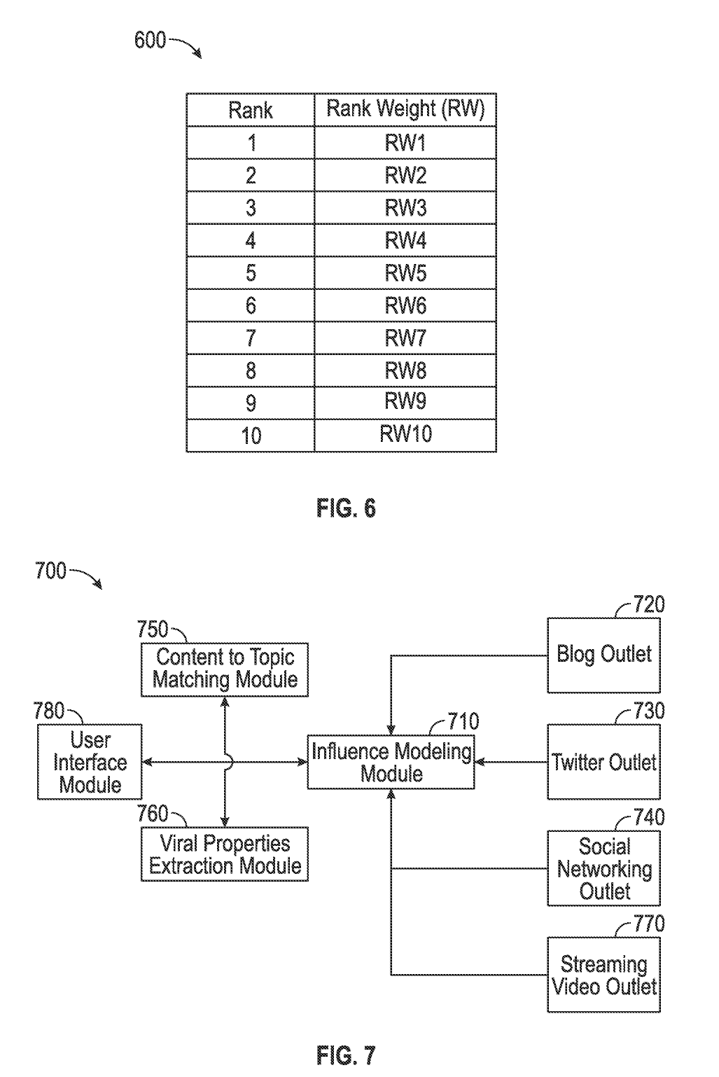

Using the exemplary values on tables 400 and 500 of FIGS. 4 and 6 respectively, and the following exemplary unitary weights:

WeightBrand=1; WeightMainstream=1; WeightSocialMedia=1; WeightSpam=1; and WeightThirdParty=1;

the following numerical values can be estimated for all the categories of content sources:

Impact_Brand_Owned=(1*100/30)*(5+5+5)/2=25%

Impact_Mainstream=(1*100/30)*(5+3+2)/2=16.67%

Impact_SocialMedia=(1*100/30)*(6+8+5)/2=31.66%

Impact_Spam=(1*100/30)*(2+2+2)/2=10%

Impact_ThirdParty=(1*100/30)*(2+2+6)/2=16.67%

In this case, the category having the highest impact on the selected brand is the Social Media content.

In a modification to this method, a rank weight (RW) can be assigned to each search result according to its rank in the overall search results, as illustrated in FIG. 6. A search result ranked 5, for example, will be assigned RW5. Additionally, each search engine K may be assigned a weight SE_K_WEIGHT to account for the different level of popularity among search engines.

By adopting the rank weight and the search engine weight, and considering the exemplary search results for N=3 search engines and TotalNumberOfEntries=2 as provided in tables 400 and 500 of FIGS. 4 and 5 respectively, each impact can now be calculated as follow:

Impact_Brand_Owned=[WeightBrand*100/(3*SUM_RW)]*[SE_1_WEIGHT*(RW1+RW3+RW4+RW1+RW3)+SE_2_WEIGHT*(RW2+RW3+RW4+RW3+RW4)+SE_3_WEIGHT*(RW1+RW2+RW3+RW1+RW3)]/2;

Impact_Mainstream=[WeightMainstream*100/(3*SUM_RW)]*[SE_1_WEIGHT*(RW7+RW8+RW2+RW7+RW8)+SE_2_WEIGHT*(RW6+RW1+RW2)+SE_3_WEIGHT*(RW9+RW9)]/2;

Impact_SocialMedia=[WeightSocialMedia*100/(3*SUM_RW)]*[SE_1_WEIGHT*(RW2+RW5+RW6+RW4+RW5+RW6)+SE_2_WEIGHT*(RW1+RW5+RW7+RW8+RW9+RW5+RW6+RW9)+SE_3_WEIGHT*(RW4+RW10+RW4+RW7+RW10)]/2;

ImpactSpam=[WeightSpam*100/(3*SUM_RW)]*[SE_1_WEIGHT*(RW10+RW10)+SE_2_WEIGHT*(RW10+RW10)+SE_3_WEIGHT*(RW5+RW5)]/2;

Impact_ThirdParty=[WeightThirdParty*100/(3*SUM_RW)]*[SE_1_WEIGHT*(RW9+RW9)+SE_2_WEIGHT*(RW7+RW8)+SE_3_WEIGHT*(RW6+RW7+RW8+RW2+RW6+RW9)]/2;

in which SUM_RW is the sum of all rank weights (RW1+ . . . +RW10).

From this array of values, the step 375 of the flowchart 300 can identify the category of content having the ownership of the selected brand by identifying the category of content with the highest impact value as discussed above.

In an alternative method, a brand ownership score for one Search Engine (Brand_Ownership_Score_1_SE) is first calculated by applying a weight to each category of content sources according to the following formula:
Brand_Ownership_Score_1_SE=(WeightBrand*(#BrandOwned/10)*100)+(WeightMainstream*(#MainstreamOwned/10)*100)+(WeightSocialMedia*(#SociallyOwned/10)*100)+(WeightSpam*(#SpamOwned/10)*100)+(WeightThirdParty*(#ThirdPartyOwned/10)*100), in which #BrandOwned is the number of search results classified under the Brand-owned content category; #MainstreamOwned is the number of search results classified under the Mainstream content category; #SociallyOwned is the number of search results classified under the Social Media content category; #SpamOwned is the number of search results classified under the Spam content category; and #ThirdPartyOwned is the number of search results classified under the Third-part content category.

The brand ownership score across all Search Engines SE_1 to SE_N (Brand_Ownership_Score_SE_1_to_SE_N) is then determined by summing across all Search Engines as follows:

Brand_Ownership_Score_SE_1_to_SE_N (Brand_Ownership_Score_1_SE_1+Brand_Ownership_Score_1_SE_2+ . . . +Brand_Ownership_Score_1_SE_N)*100/N

in which Brand_Ownership_Score_1_SE_k is the brand ownership score for search engine k and N is the number of search engines.

The following illustrates an example of this equation, used against one search engine with exemplary values of: [BrandOwned=5%*WeightBrand=10%+MainstreamOwned=15%*WeightMainstream=20%+SocialMediaOwned=70%*WeightSocialMedia=60%+SpamOwned=2%*WeightSpam=5%+ThirdPartyOwned=8%*WeightThirdParty=5%]*100/Number Of Engines=1]=[0.005+0.03+0.42+0.001+0.004]*100/1=0.46*100/1

Brand Ownership Score=46

The brand ownership score can be stored in a time series, allowing for a trend analysis to be performed, determining how the brand ownership score changes and if more control is moving to communities for a particular brand, or if that control is moving to others, such as mainstream media.

In an alternative method of calculation, the number L of search results considered is extended over two or more pages, with each page having an assigned weight according to its level in the set of pages considered.

The embodiments of the present invention provided numerous advantages, most importantly, allowing public relation professionals to make preemptive marketing decisions that are not available today.

Thus, an improved method and system for determining a measure of various categories of media owners, e.g., social media, on a corporate brand have been provided.

### Topical On-Line Influence Summary

According to the embodiments described below, a topical on-line influence is introduced, which is a measure of how many people are engaged in a message of an entity (an individual, an organization, or a company) around a given topic. UserA has a higher influence around topicA then userB if postings by the userA that match topicA garner more influence metrics, quicker and higher in total count, then the userB. Engagement/influence metrics, also referred to as viral properties, are defined as the various social media popularity metrics such as comment count, unique commenter count, inbound link count, breadth of reply, views, bookmarks, votes, buries, favorites, awards, acceleration, momentum, subscription counts, replies, spoofs, ratings, friends, followers, posts, and updates.

The topical on-line influence is first defined for each form of content or social media outlet by using a first influence model taking into account weighted viral properties for the form of content, and then calculating across various forms of content by using a second influence model, which takes into account weighted topical influences for different forms of content.

A user is allowed to manipulate the first and second influence models by adding additional viral properties to equations used in the models, or removing certain viral properties from the equations, and by adjusting weights in the equations.

According to one aspect of the invention, there is provided a method for determining topical on-line influence of an entity, comprising the steps of: defining an entity; introducing a social topic; selecting a form of social media content; matching and tagging content of the selected form of content with the topic; introducing influence metrics for the selected form of content and collecting values of the influence metrics; determining topical influence for the selected form of content according to an influence model by taking into account the collected values of the influence metrics; and determining topical influence of the entity according to an influence model by taking into account the topical influence for one or more selected forms of content.

According to one aspect of the invention, there is provided a method for determining topical on-line influence of an entity, comprising the steps of: (a) matching and tagging content, published by the entity through a social media outlet, with a selected topic; (b) extracting one or more viral properties from the tagged content; (c) determining topical on-line influence of the social media outlet according to a first influence model by taking into account the extracted viral properties; and (d) determining topical on-line influence of the entity according to a second influence model by taking into account the topical on-line influence for one or more social media outlets associated with said entity. Beneficially, the step (b) comprises: collecting values of the viral properties for each tagged content; and aggregating the collected values across the tagged content. The step (b) further comprises: collecting values of the viral properties at predetermined time intervals; and storing the collected values in respective time series.

Conveniently, the viral properties are selected from the group consisting of: user engagement value; average comment count; average unique commentor count; cited individual count, inbound links; subscribers; average social bookmarks; average social news votes; buries; total count of posts; and total count of appearance of Individuals names across all posts.

The step (c) comprises defining the first influence model as a linear combination of the extracted one or more viral properties weighted with respective weights associated with each of the extracted viral properties.

The step (d) comprises defining the second viral properties as a linear combination of the topical on-line influence of the social media outlets weighted with respective weights associated with each of the social media outlets.

Conveniently, the step (a) comprises selecting the social media outlet from the group consisting of: a social networking outlet; a blog outlet; a video streaming outlet; an image sharing outlet; a podcast outlet; a web analytics outlet; a peer-to-peer torrent outlet; a live stream outlet; a main stream outlet; and a social news outlet.

In the method described above, the entity is selected for the group consisting of: an individual; an organization; and a corporation.

Thus, the embodiments provide a computer implemented method and system for automatically calculating the influence an individual, a named group, or company, over others by recording various social media engagement/influence metrics over time by applying a sequence of weighted equations.

The method further comprises identifying top influencers, whose topical on-line influence value is above a predetermined threshold, and displaying the results on a computer screen.

The method of further comprises identifying top movers among entities, comprising determining a speed of change of the topical on-line influence values for the entities, and displaying the results on a computer screen.

According to another aspect of the invention, there is provided a method for determining a topical on-line influence, comprising steps of: (a) defining an entity; (b) selecting a topic; (c) selecting a social medial outlet associated with said entity; (d) retrieving pieces of content posted by said entity from the social media outlet, which match the selected topic; (e) extracting viral properties of the retrieved pieces of content; and (f) determining topical on-line influence of the social media outlet based on the extracted viral properties; and (h) determining a topical on-line influence model of the entity based on the topical on-line influence for one or more social media outlets associated with said entity.

Advantageously, the step (e) further comprises collecting values of viral properties for each piece of content and aggregating them across all pieces of content.

In the embodiment of the invention, the step (f) comprises determining a linear combination of the extracted viral properties weighted with respective weights associated with each of the extracted viral properties.

The step (h) comprises determining a linear combination of the topical on-line influence of the social media outlets weighted with respective weights associated with each of the social media outlets.

Conveniently, said one or more social media outlets are selected from the group consisting of a social networking outlet, a blog outlet, a video streaming outlet, an image sharing outlet, a podcast outlet, a web analytics outlet, a peer-to-peer torrent outlet, a live stream outlet, a main stream outlet, and a social news outlet.

According to yet one more aspect of the invention, there is provided a system for determining a topical on-line influence of an entity, comprising: a computer, having a microprocessor and a computer readable medium, storing computer readable instructions, for execution by the processor, to form the following: (a) a matching module for matching and tagging content to a selected topic said content published by said entity through a social media outlet; (b) a viral properties extraction module for extracting viral properties from the tagged content; (c) an outlet influence modeling module for calculating a topical on-line influence for the social media outlet according to an influence model by taking into account the extracted viral properties; and (d) an entity influence modeling module for calculating the topical on-line influence of the entity according to an influence model by taking into account the topical influence for one or more social media outlets associated to said entity; the microprocessor processing operations of said matching module, said viral protection extraction module, said outlet influence modeling module and said entity influence modeling module.

The viral properties extraction module comprises a means for collecting values of the viral properties at predetermined time intervals and storing the collected values in respective time series.

The system further comprises a user interface module for defining the entity, associating the social media outlets with the entity, and assigning weights for each of said viral properties and for each of said social media outlets.

The user interface module further comprises means for graphically displaying results of the calculation of the topical on-line influence for the entity.

A computer readable medium is also provided, comprising a computer code instructions stored thereon, which, when executed by a computer, perform the steps of the method described above.

Thus, the embodiments of the present invention provide a computer implemented method and system for automatically calculating the influence of an entity by recording various social media engagement/influence metrics over time and processing the recorded metrics, e.g., by applying a sequence of weighted equations.

### Topical On-Line Influence Details

Embodiments of the invention describe influence measurement models for determining the influence in social media, in particular, for determining a topical on-line influence of an entity.

The measurements are topically relevant, and can be cross channel aggregated, i.e. aggregated across various forms of content or social media outlets or Internet social media sites. The influence module takes into account that entities may engage in social media in a number of ways, using a number of technologies and different social media sites.

Influence is calculated around user defined topics. Users define topics in one of three ways: (1) by creating a topic container: a collections of words, phrases, and necessary Boolean logic that describes a subset of all possible social media content, usually centered around a brand, name, field of study, market, concept, or product; (2) by creating a source container: a collection of media sources (specific Internet sources) that exclusively talk about a given topic; or (3) by creating a topic model: a trained text classification model created by feeding a text classifier a labeled corpus of on topic and not on topic content (the classifier can then gauge unlabeled data based on how closely it matches the trained topic model).

Once the topics are defined, all discovered social media content is passed through an analysis phase where the content is tagged with which topics it relates to. If the content does not match any defined topics, it is disregarded.

Entities may have one or more channels/sites where they publish content. Additionally, they may publish different forms of content. Channels are defined as an outlet of one form, through which a user regularly publishes some form of content. Across all these, entities may have established a presence and garnered a listening and engaged following of users. Therefore, the model independently calculates an influence metric for each type of content or interactive site and aggregates these separate influence metrics into a single metric. Embodiments described herein take into account that calculation and definition of influence are different per form of content or site due to the fact that the measureable effects of these sites are different. For example, for posted videos, measurement of viewership is available, but it is not available for blogs. Alternatively, for blogs, RSS (Really Simple Syndication) subscribers are measureable, but not the numbers of “friends.” For some micromedia sites, there are “followers,” but number of link-backs is irrelevant. Even where similar metrics are available across the different forms of content, their relevance in a blended influence metric is taken into account.

The influence model takes into account (1) that the amount of on topic content coupled to user engagement and other metrics gives us a measure of what people are following and listening to the author for; (2) that an entity owns one or many cannels, and that their following is spread across these channels, and that the demographic breakdown of the listeners in different channels is not necessarily similar; (3) the fact there needs to be unique influence and user engagement equations developed specifically for each social media form of content or channel type; and (4) the fact that the definition of influence and the importance of the viral properties that make up the influence are not hard and fast elements, and that expert knowledge is taken into account to ensure that the resulting lists are generated with the business goals of the expert as a first priority.

FIG. 7 illustrates a system architecture for implementing the embodiments of the present invention. As shown in FIG. 7, the system 700 comprises a processor and a computer readable medium having instructions stored thereon, for execution by the processor, to form the modules of the system 700 as will be described below. The system 700 comprises a Content-to-Topic Matching Module 750 for generating tagged content, which is connected to a Viral Properties Extraction Module 760 for extracting viral properties from the tagged content. The Influence Modeling Module 710 processes the tagged content and the viral properties, and generates a topical on-line influence model of a social media outlet 720, 730, 740, 770 associated with an entity. The Influence Modeling Module 710 generates also a topical on-line influence model of an entity combining all the topical on-line influences of the social media outlets associated with the entity. A social media outlet in this instance is a form or type of content such as a blog, a micromedia-based content, a video channel content, a user profile page, or a social networking-based content. As shown in FIG. 7, a blog outlet 720, a twitter outlet 730, a social networking outlet 740 and a streaming video outlet 770 are connected to the Influence Modeling Module 710. In this instance, the Influence Modeling Module 710 generates a topical on-line influence model for each of the social media outlet as well as a topical on-line influence model for the entity associated with the social media outlets 720, 730, 740, 770 shown in FIG. 7.

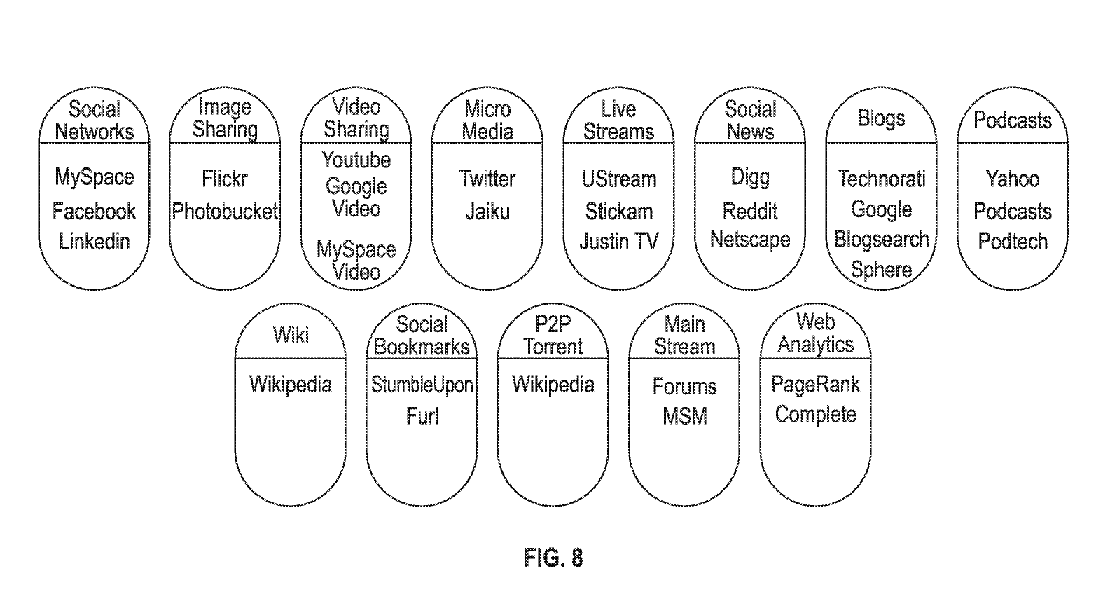

FIG. 8 of the present application shows another exemplary list of social media outlets that can be used in the embodiments of the present invention.

As mentioned above, the system 700 illustrated in FIG. 7 is implemented in one or more software modules, comprising computer readable instructions stored in a computer readable medium of a computer, for example, a general purpose or specialized computer, having a central processing unit (CPU), and a memory and other storage devices such as CD, DVD, hard disk drive, etc. As an example, modules of the system 700 can be implemented as individual software modules running on the same hardware platform. Alternatively, modules of the system 700 can be implemented on different hardware platforms, e.g., on different computers connected in a network. Other implementations are possible and are well known to the persons skilled in the art.

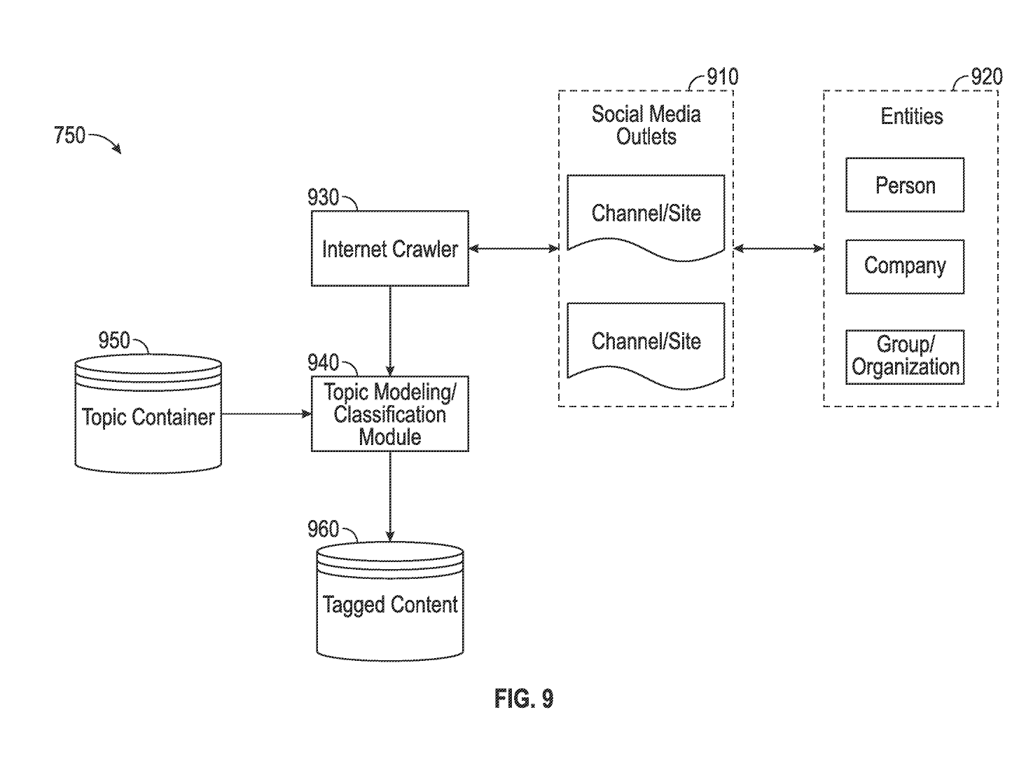

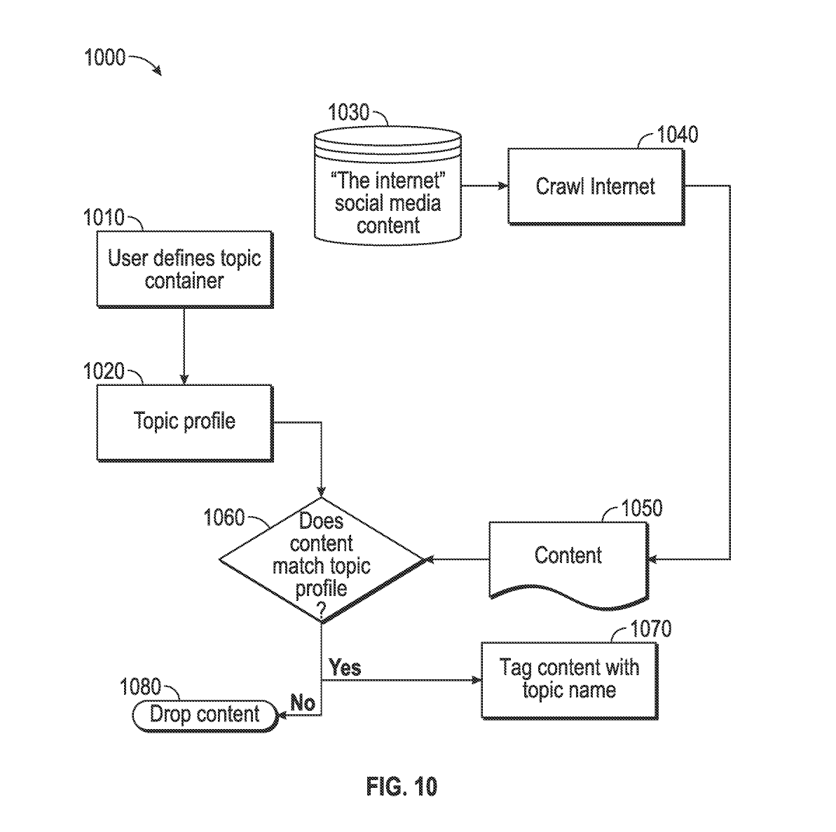

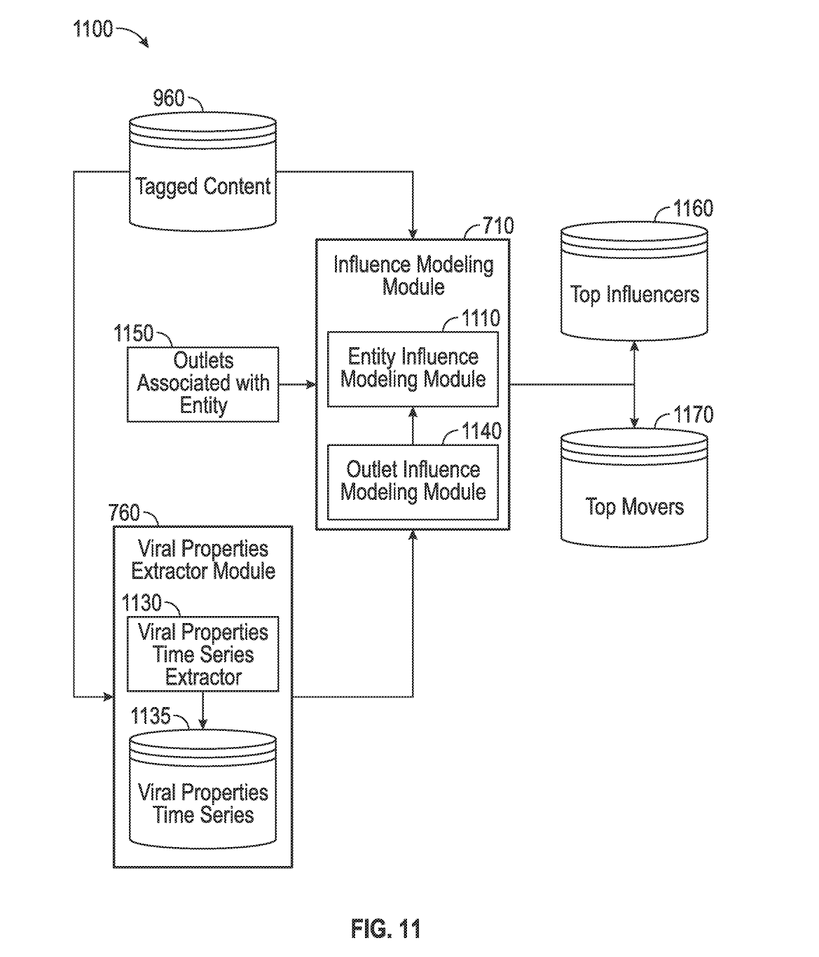

The Content-to-Topic Matching Module 750 of the system 700 matches accessed content with user-defined topics to produce tagged content. The architecture and operation of this module will be described with reference to FIG. 9 and FIG. 10 below. The Viral Properties Extraction Module 760 extracts viral properties from tagged content by collecting the viral properties at predetermined time intervals and storing them in a time-series format. The Content-to-Topic Matching Module 750 will be described with reference to FIGS. 11-13 below.

A user interface module 780 is also provided to allow a user to interact with the system 700. The user interface module 780 comprises a computer readable code stored in a computer readable medium, which, when executed, provides a graphical user interface (GUI), or a command-line interface, to allow a user to interact with the system 700. For example, the GUI provided by the user interface module 780 can be used for setting a schedule for collecting values of the viral properties.

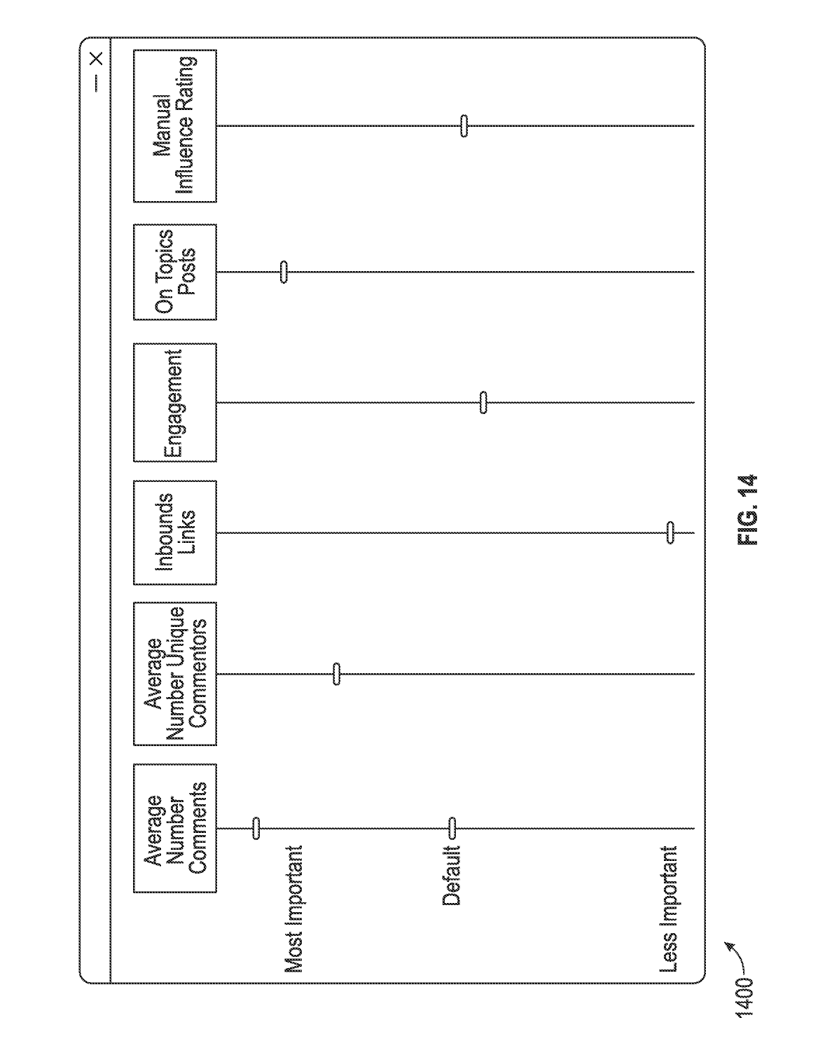

Additionally, and will be shown with regard to FIG. 14 below, a user can setup or modify weights associated with various viral properties or with social media outlets, which are used in the determination on the influence models through a view 1400 of a graphical interface provided by the user interface module 780. As shown in FIG. 14, the user can set the values of the weights which reflect their level of importance in the determination on the influence models.

FIG. 9 illustrates the Content-to-Topic Matching Module 750 of the system 700 in more detail. The diagram 750 shows entities 920 such as an individual, a company, or a named group or organization, which may have one or more channels/sites collectively referred to as social media outlets 910 where they publish some form of content. The social media outlets 910 are accessible to an Internet Crawler 930 which is connected to a Topic Modeling/Classification Module 940. The Topic Modeling/Classification Module 940 is also connected to a Topic Container 950, from which it receives topic-related information. The Topic Modeling/Classification Module 940 processes the topic-related information and content retrieved by the Internet crawler 930 to match the content to a defined topic. The matched content is then stored in a tagged content database 960.

The Topic Container 950 is a collection of words, phrases, and necessary Boolean logic that describes a subset of all possible social media content, usually centered around a brand, name, field of study, market, concept, or product.

The Topic Modeling/Classification Module 940 defines a topic model, which is a trained text classification model, created by feeding, to a text classifier, a labeled corpus of on-topic and not on-topic content. The classifier can then gauge unlabeled data based on how closely it matches the trained topic model. Text or content classification methods are well known and any of those methods can be used to classify and tag the content.

The operation of the Content-to-Topic Matching Module 750 will now be described in more detail with reference to a diagram 1000 of FIG. 10. At step 1010, a user defines, through the interface of the user interface module 780 of FIG. 7, a topic container such as “Social Media” encapsulating a topic profile 1020 against which retrieved content need to be matched. For example, the topic profile 1020 may include terms such as ‘blogging’, ‘social media’, ‘social networking’, and ‘video sharing’ and others which describe the topic container “Social Media”.

At step 1040, social media content 1030 are identified by crawling the Internet and the discovered social media content 1050 are presented to an analysis phase. All discovered social media content 1050 are passed through the analysis phase at step 1060 where the content is matched against the topic profile 1020. If the content does not match the topic, it is disregarded (step 1080). If a match is found, the content is then tagged with the corresponding term in the topic profile (step 1070).

FIG. 11 shows a block diagram for a system for determining a topical on-line influence of an entity according to the embodiment of the invention. The Tagged Content 960 is provided in connection with the Viral Properties Extraction Module 760. The tagged content 960 as described above is a content that matches a selected topic profile and identifies the channel/site hosting the content.

Viral Properties Extraction Module 760, through its Viral Properties Time Series Extractor 1130, extracts the viral properties related to the tagged content 960 and stores them in time series in the viral properties database 1135 so that the history of each viral property is recorded. Viral properties, also referred to as influence metrics, are defined as the various social media popularity metrics. Examples of viral properties include but are not limited to: User engagement across topically relevant posts, wherein the engagement is measured by the length of the commenting threads and the number of unique commentors; Average Comment count across topically relevant posts; Average unique commentor count across topically relevant posts; Cited individual count; Inbound links across topically relevant posts; Blog subscribers across all posts; Average Social bookmarks across all topically relevant posts; Average Social news votes and buries across all topically relevant posts; Total Count of topically relevant posts; and Total Count of appearance of Individuals names across all posts.

Other influence metrics include breadth of reply, views, bookmarks, votes, buries, favorites, awards, acceleration, momentum, subscription counts, replies, spoofs, ratings, friends, followers, posts, and updates.

As the individual pieces of content have been collected, the originating sources are extracted, and a profile for the origin is created within the system. As each piece of topic matching media within a given medium or form of content is collected, various viral properties are also collected. Collection of the viral properties for a piece of media entails, but is not limited to, and changes depending on the social media technology being analyzed, connecting to the origin site, requesting the pieces of media, and scraping values from the returned web documents that correspond to the desired viral properties. Each piece of content that matches the topic container is scheduled to have its viral properties extracted on a regular schedule, and stored in time series so that the history of each viral property is recorded. The schedule used for time extracting of the viral properties changes as the recorded viral property values are analyzed. For example, if upon checking the viral properties for a blog post on a 3 hour schedule, it is determined that the number of new comments has exploded, then the schedule will be altered to ensure that the viral properties are checked more frequently. Conversely, if the comment count has changed little or not at all, the schedule may be changed to check with half the frequency, down to every 6 hours. Conveniently, different viral properties may have same or different time extraction schedules.

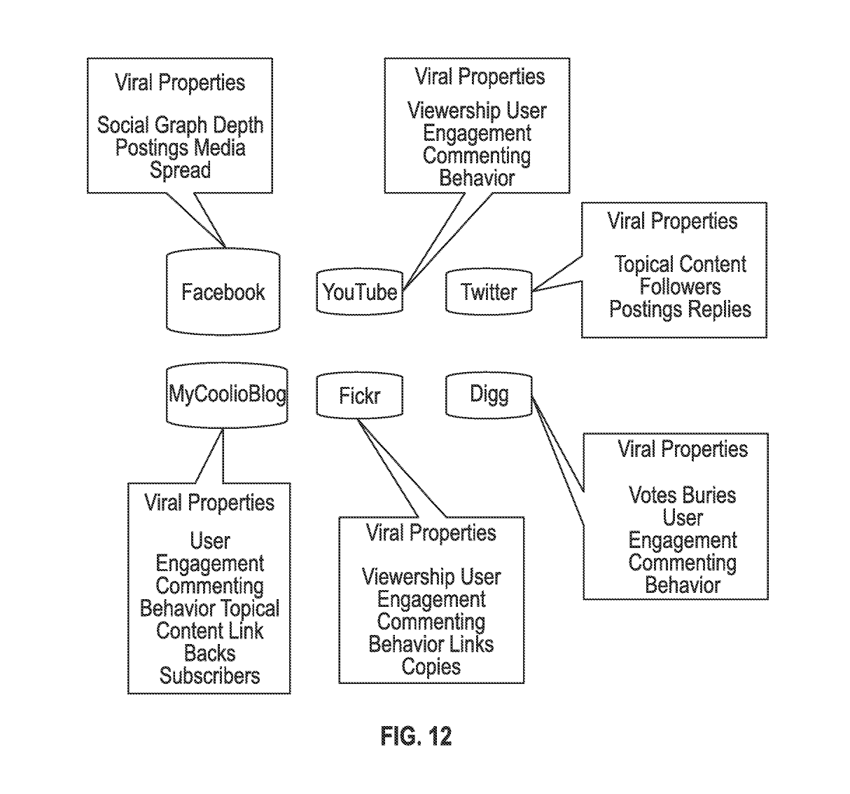

FIG. 12 shows some specific viral properties that are extracted for various forms of content, and their weights are set accordingly as illustrated in FIG. 14.

An Outlet Influence Modeling Module 1140 receives viral properties from to the Viral Properties Time Series Extractor 1130 and computes the influence of every single social media outlet associated with the entity. In computing the influence of a social media outlet, the Outlet Influence Modeling Module 1140 receives also user-defined influence weights for each collected viral properties of a social media outlet and applies a first influence model involving the weights of the viral properties of all the tagged content posted or published by the entity through the social media outlet.

An Entity Influence Modeling Module 1110 creates a topical on-line influence model of the entity based on the respective topical influence of the social media outlets associated with the entity (module 1150) and calculated by the Outlet Influence Modeling n Module 1140.

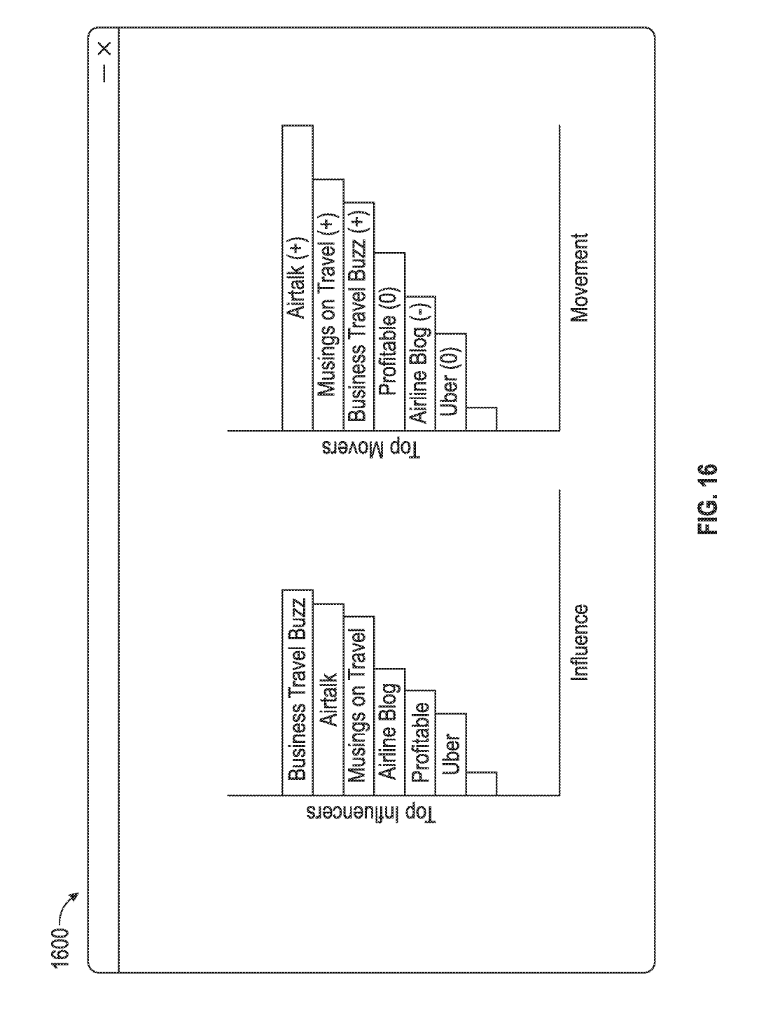

The Entity Influence Modeling Module 1110 also generates a listing of top influencers 1160 based on the influence value of the entities. This listing identifies most influential entities in a given topic. Additionally, the Entity Influence Modeling Module 1110 also generates a listing of top movers 1170 for a given topic. The listing of top movers 1170 is representative of entities having rapidly-changing influence values. A graphic representation of top influencers and top movers on a GUI provided by the user interface module 780 is shown in FIG. 16 and will be described hereinafter.

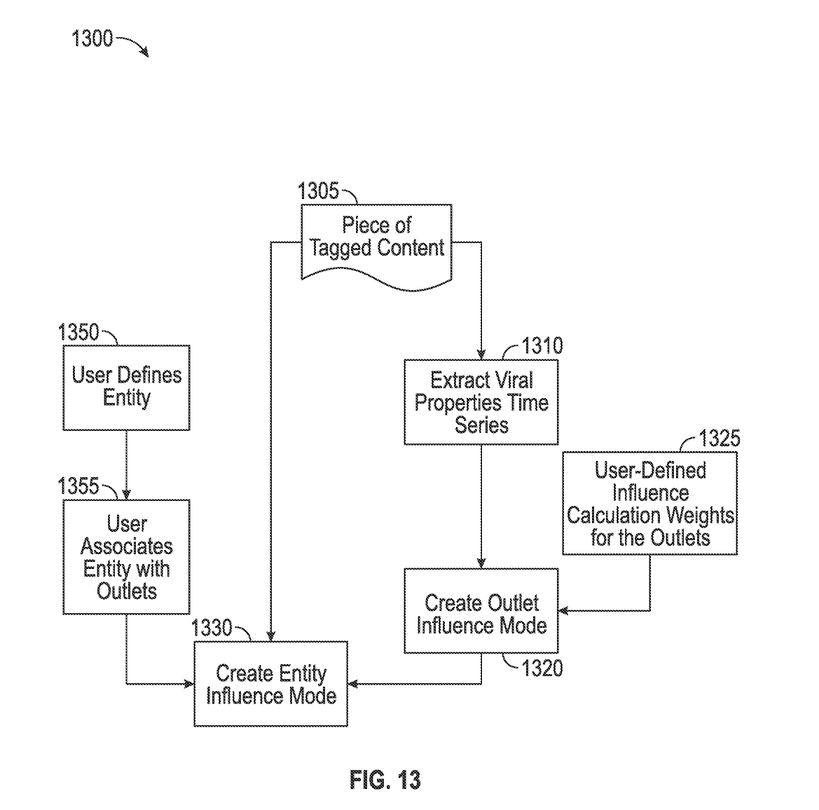

FIG. 13 illustrates a flowchart 1300 describing an operation of the influence modeling module 710 shown in FIG. 7. FIG. 13 will now be described by considering an example involving an imaginary user named Robert Scoble, who is a heavy user of social media technologies, and very influential on the topic of social networking, and blogging. In the embodiment of the present invention, Robert Scoble is an entity. He generates a lot of media, through a number of different social media outlets. Robert is a prolific blogger, Twitter user (which is a micromedia technology), Facebook user (Social Networking), and streaming video user (Kyte.tv). These are Robert's 4 primary social media outlets, and his audience is the collective audience across the 4 social media outlets. His influence in each social media outlet is specific to the social media outlet itself, and relative to others. For example, Robert is very influential and heavily read blogger, to whom many others are compared, but his Kyte.tv streaming video channel may look pale in comparison to channels by other authors on Kyte.tv.

As illustrated in the flowchart 1300, each piece of content 1305 that matches the topic container 950 is scheduled to have its viral properties extracted at step 1310 on a regular schedule, and stored in time series so that the history of each viral property is recorded. Each piece of content 1305 has a social media outlet (e.g. site, channel for video streaming, or user profile page) where it has originated. For blogs, a blog post is a piece of content, and the blog site is the originating site. For a recorded streaming video, the origin is the user's channel on the streaming video provider's site. For a Tweet (a posting on Twitter), the origin is the user's profile page.

The schedule used for time extracting of the viral properties changes as the recorded viral property values are analyzed. For instance, if upon checking the viral properties for a blog post on a 3 hour schedule, it is determined that the number of new comments has exploded, then the schedule will be altered to ensure that the viral properties are checked more frequently. Conversely, if the comment count has changed little or not at all, the schedule may be changed to check with half the frequency, down to every 6 hours. Conveniently, different viral properties may have same or different time extraction schedule.

The extracted viral properties are used at “Create Outlet Influence Model”, step 1320 to determine the influence of each of the social media outlets based on the viral properties collected from each of the pieces of content 1305 and following a first influence model. Following up on the example above, the influence model for determining the influence of the blog associated with Robert Scoble can be expressed as a linear combination of viral properties such as in the following equation:

CalculatedBlogInfluence=(Weight 1*BlogEngagement)+(Weight2*Average comment Count)+(Weight3*Average Unique Commentor Count)+(Weight4*Inbound Links)+(Weight5*Blog Subscribers)+(Weight6*Bookmarks)+(Weight7*Votes)+(Weight8*Count of Topically relevant posts), where Weight1-Weight8 are respective weight factors defining the relevant contribution of various viral properties into the topical influence value for this blog, and the topical influence value is conveniently normalized to a scale of 0-100. The weight for each type of social media outlet is also user-defined and is entered at “User-Defined Influence Calculation Weights for the outlets” step 1325.

In the embodiment of the present invention, a user is responsible for adjusting the weights for the above noted equation to reflect the viral properties that, in the user's opinion, are most telling of the business goals he or his clients have set forth. The user's adjusted weights are saved on a per topic basis, allowing for a different topic to have a different weighting system to align with potentially different business goals.

The user adjusts the weights from the user interface 780 illustrated in FIG. 7 and sets their value according to their level of importance as shown in FIG. 14 described above.

As with blogs, viral properties are extracted for each piece of topically relevant media published by Robert Scoble through his video streaming outlet on Kyte.tv. The viral property values are stored in a time series and used in determining the influence for the video streaming outlet. The equation for determining the influence is as follows:

Calculated VideoChannelInfluence=(Weight11*Average Concurrent Viewership)+(Weight12*Total Views)+(Weight13*Inbound Links)+(Weight14*Engagement)+(Weight15*Average Comment Count)+(Weight16*Unique Commentor Count)+(Weight17*Count of Topically Relevant Posts), where Weight11-Weight17 are respective weight factors defining the relevant contribution of various viral properties into the topical influence value of this form of content, and the topical Influence value is conveniently normalized to a scale of 0-100.

Assuming that similar work has been done to find Robert Scoble's Twitter presence, and his Facebook profile, to calculate respective MicroMediaInfluence and SocialNetworkInfluence for these two social media outlets using viral properties specific to the two forms of content (as illustrated in FIG. 12) and other additional viral properties in a manner already described above with regard to the calculations of the CalculatedBlogInfluence and CalculatedVideoChannelInfluence. Thus, there are now four separate social media outlets, on which Robert Scoble has established followers and exerts some level of influence.

To connect the four social media outlets within the system, a new entity profile, of type ‘person’, and name it ‘Robert Scoble’ is created at step 1350. As described above, entities can have different types such as Person/individual, Organization, or Company. The user then associates, at step 1355, the Robert Scoble blog site, the Robert Scoble Kyte.tv channel, Robert Scoble's Twitter profile, and his Facebook account to the entity profile ‘Robert Scoble’.

At “Create Entity Influence Model”, step 1330, an entity influence model is created based on a weighted aggregation of the topical on-line influences of all the social media outlets associated with Robert Scoble.

All defined entities have user weighted influence quation to calculate the topical online influence across various social media outlets. Because entities may wield more influence in one form of content then another, the weights can be applied on a perentity basis, e.g., the user may adjust the weights on Robert Scoble's Influence equation to one set of values that are different from the weights they apply to other entities in the system. In the absence of a user defined custom set of weights for an entity's influence, the system default influence equation weights will be used for that entity type. All entity types will have a default set of weights defined in the system that will be used in absence of user defined weights.

An exemplary linear equation for determining a topical on-line influence of the entity “Robert Scoble” is as follows: EntityInfluence=((Weight111*CalculatedBlogInfluence)+(Weight222*CalculatedVideoChannelInfluence)+(Weight333* CalculatedMicroMediaInfluence)+(Weight444*CalculatedSocialNetworkInfluence))/4, where Weight111-Weight444 are respective weight factors defining the relevant contribution of various forms of content in to the final entity influence value.

The resulting value of the topical on-line influence of the entity is in the range of 0-100 and represents an influence score for the entity that takes into account two layers of user defined expert knowledge via the weighting model at the social media outlet layer (e.g. the weights on the viral properties used in the determination of the influence score for a blog) and across various social media outlets (the weights on each social media outlet relative to each other).

The example described above considers 4 social media outlets associated with Robert Scobble. Additional social media outlets such as Social News, ImageSharing or other listed in FIG. 8 can very well be associated with Robert Scobble. The EntityInfluence can then be expressed in a generic form of a topical on-line influence model integrating all social media outlets associated with the entity as follows:

EntityInfluence=((Weight1*outlet.sub.—1_Influence)+(Weight2*outlet.sub.—2_Influence)+ . . . +(Weightn*outlet_n_Influence))/n, where Weight1-Weightn are respective weight factors defining the relevant contribution of various social media outlets (outlet_{—}1-outlet_n) in to the final entity influence value. Other formulas based on linear or non-linear functions could also be used to model the topical on-line influence of the social media outlets or the topical on-line influence of the entity.

As stated above and shown in FIG. 7, a user interface module 780 is included in the present invention to provide an interface (e.g. GUI) for interacting with the system 700.

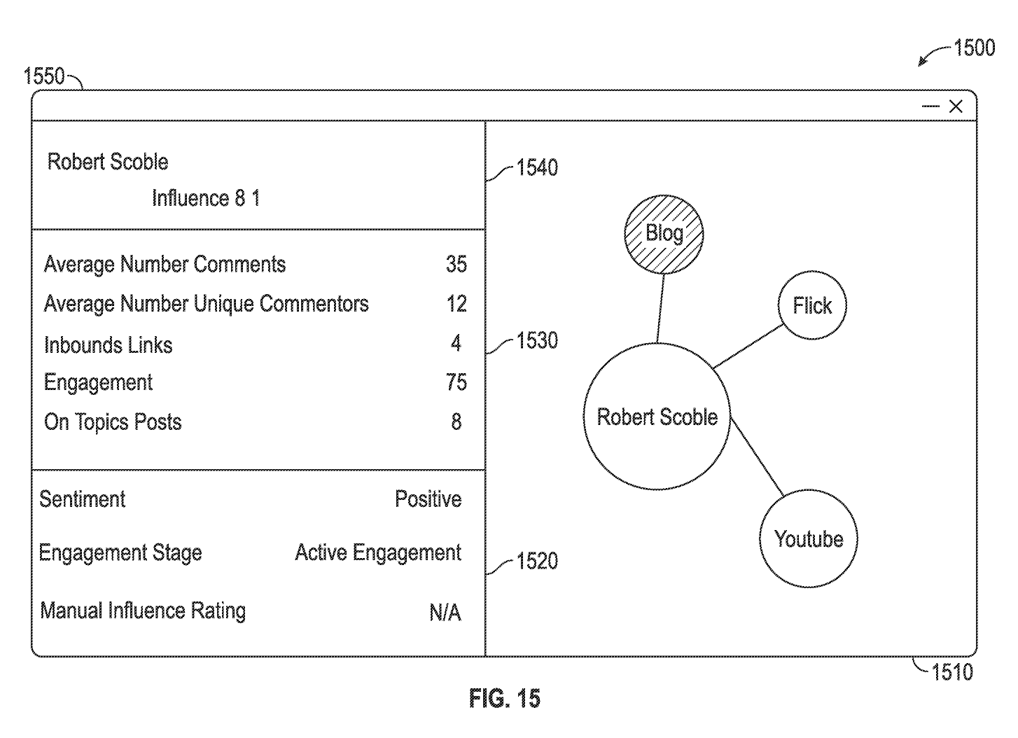

FIG. 15 shows an exemplary view 1500 representing one form of the GUI. Section 1510 of the view 1500 shows the network of social media outlets associated with the entity Robert Scoble. Section 1550 shows some menu options such as “close” and “minimize” (X and _{—} respectively). Section 1540 shows the influence score of the entity while section 1530 shows the individual values of the viral properties collected for a selected social media outlet (in this instance the blog outlet 720).

Section 1520 of FIG. 15 shows user defined parameters that can be adjusted or included in the influence models. As an example, the user may add new properties to the equation. For instance, the user may decide to include a manual sentiment score in the range of 0 to 100, with 0 being neutral included in the calculations for blog sites, but not for any of the other social media outlets. The user can go to a configuration panel (not shown) and edit the equation for CalculatedBlogInfluence, adds a new viral property from section 1520, defines its range and sets its default weight. After performing such actions, the new CalculatedBlogInfluence equation becomes as follows: CalculatedBlogInfluence=(Weight1*BlogEngagement)+(Weight2*Average comment Count)+(Weight3*Average Unique Commentor Count)+(Weight4*Inbound Links)+(Weight5*Blog Subscribers)+(Weight6*Bookmarks)+(Weight7*Votes)+(Weight8*Count of Topically relevant posts)+(Weight9*ManualSentimentScore).

FIG. 16 shows a graphical representation 1600 of top influencers and top movers for a given topic. As stated above, the Entity Influence Modeling Module 1110 can generate a listing of top influencers 1160, whose topical on-line influence value is above a predetermined threshold, and a listing of top movers 1170, whose speed of change of the topical on-line influence is above a predetermined threshold. These two listings can be represented graphically as shown in FIG. 16 with an indication of the movement of the influence values among the top movers. As shown in FIG. 16 influence values of the entities may have positive (+) movement, negative (−) movement or neutral (0) movement. The movement can be calculated from a rate of change of the influence value over a period of time. For example if an Entity A has an influence value that changes from 8 to 13 within a fixed period T, its rate of change would be 5/T. Entities having the highest rate of change in absolute value will be included in the listing of top movers 1170.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application. Accordingly, details of the exemplary embodiments or other limitations described above should not be read into the claims absent a clear intention to the contrary.

What is claimed is:

1. A computer system comprising:
a database to store a brand profile, the brand profile comprising a list of words and phrases;
a computer coupled to the database and the Internet, the computer comprising a processing module and a memory storing computer readable instructions for execution by the processor to provide:
a search engine interface to query each search engine of a set of search engines over the Internet using the words and phrases from the brand profile stored in the database as search terms and retrieve a predetermined number of search results returned by each search engine of the set of search engines;
a classification engine to classify the predetermined number of search results retrieved by the search engine interface from each search engine of the set of search engines into a plurality of categories of content sources by assigning each search result of the predetermined number search results from a respective search engine to a respective category of the plurality of categories of content sources based on a respective origin site associated with each respective search result, resulting in classified search results; and
a score calculation engine to calculate, for each category of the plurality of categories of content sources, a respective impact value across the set of search engines based on the classified search results and identify a first category of the plurality of categories of content sources having a highest impact value.

2. The computer system of claim 1, wherein:
the brand profile includes uniform resource locators associated with a brand;
the plurality of categories of content sources includes a brand owned category; and
the classified search results include one or more search results of the predetermined number search results assigned to the brand owned category based on comparing the respective origin site of the one or more search results to the uniform resource locators associated with the brand.

3. The computer system of claim 2, wherein:
the plurality of categories of content sources includes a community owned category; and
the classified search results include a second set of one or more search results of the predetermined number search results assigned to the community owned category based on comparing the respective origin site of the one or more search results of the second set to a list generated by an automated social media monitoring service.

4. The computer system of claim 3, wherein:
the plurality of categories of content sources includes a mainstream media owned category; and
the classified search results include a third set of one or more search results of the predetermined number search results assigned to the mainstream media owned category based on comparing the respective origin site of the one or more search results of the third set to a list of online mainstream media outlets maintained by a third party.

5. The computer system of claim 4, wherein:
the plurality of categories of content sources includes a spam owned category; and
the classified search results include a fourth set of one or more search results of the predetermined number search results assigned to the spam owned category based on the respective origin site of the one or more search results of the fourth set using one or more spam filters.

6. The computer system of claim 5, wherein:
the plurality of categories of content sources includes a third party category; and
the classified search results include a fifth set of one or more remaining search results of the predetermined number search results assigned to the third party category based on the one or more remaining search results not being classified into the brand owned category, the community owned category, the mainstream media owned category, or the spam owned category.

7. The computer system of claim 1, wherein score calculation engine calculates the respective impact value for each category of the plurality of categories of content sources based on a number of search results classified under the respective category, a respective rank weight assigned to each respective search result of the number of search results classified under the respective category, and a respective search engine weight assigned to a respective search engine of the set of search engines associated with each respective search result of the number of search results classified under the respective category.

8. The computer system of claim 7, wherein the respective rank weight is assigned to each respective search result according to its rank in the predetermined number of search results retrieved from the respective search engine of the set of search engines associated with the respective search result.

9. The computer system of claim 7, wherein the respective search engine weight accounts for a level of popularity of the respective search engine among the set of search engines.

10. The computer system of claim 1, wherein the score calculation engine calculates a brand ownership score based on the classified search results.

11. The computer system of claim 10, further comprising a time series data store to store the brand ownership score in a time series to allow for a trend analysis to be performed.

12. The computer system of claim 11, wherein the trend analysis comprises charting out control moving from the first category of the plurality of categories to a second category of the plurality of categories.

13. A computer readable medium, comprising a computer code instructions stored thereon, which, when executed by a processing module of a computer coupled to the Internet and a database storing a brand profile comprising a list of words and phrases, cause the computer to:
query, over the Internet, each search engine of a set of search engines using the words and phrases from the brand profile stored in the database as search terms to retrieve a predetermined number of search results returned by each search engine of the set of search engines;
classify the predetermined number search results retrieved from each search engine of the set of search engines into a plurality of categories of content sources by assigning each search result of the predetermined number search results from a respective search engine to a respective category of the plurality of categories of content sources based on a respective origin site associated with each respective search result, resulting in classified search results;
calculate, for each category of the plurality of categories of content sources, a respective impact value across the set of search engines based on the classified search results, resulting in a plurality of impact values; and
identify a first category of the plurality of categories of content sources having a highest impact value of the plurality of impact values.

14. The computer readable medium of claim 13, wherein:
the brand profile includes uniform resource locators associated with a brand; and
the computer code instructions cause the computer to classify the predetermined number search results by assigning one or more search results of the predetermined number search results to a brand owned category of the plurality of categories based on comparing the respective origin site of the one or more search results to the uniform resource locators associated with the brand.

15. The computer readable medium of claim 14, wherein the computer code instructions cause the computer to classify the predetermined number search results by assigning a second set of one or more search results of the predetermined number search results to a community owned category based on comparing the respective origin site of the one or more search results of the second set to a list generated by an automated social media monitoring service.

16. The computer readable medium of claim 15, wherein the computer code instructions cause the computer to classify the predetermined number search results by assigning a third set of one or more search results of the predetermined number search results to a mainstream media owned category based on comparing the respective origin site of the one or more search results of the third set to a list of online mainstream media outlets maintained by a third party.

17. The computer readable medium of claim 16, wherein the computer code instructions cause the computer to classify the predetermined number search results by:
assigning a fourth set of one or more search results of the predetermined number search results to a spam owned category based on the respective origin site of the one or more search results of the fourth set using one or more spam filters; and
assigning remaining search results to a third party category after assigning search results to the brand owned category, the community owned category, the mainstream media owned category, and the spam owned category.

18. The computer readable medium of claim 13, wherein the computer code instructions cause the computer to calculate the respective impact value for each category of the plurality of categories of content sources based on a number of search results classified under the respective category, a respective rank weight assigned to each respective search result of the number of search results classified under the respective category, and a respective search engine weight assigned to a respective search engine of the set of search engines associated with each respective search result of the number of search results classified under the respective category.

19. The computer readable medium of claim 18, wherein the respective rank weight is assigned to each respective search result according to its rank in the predetermined number of search results retrieved from the respective search engine of the set of search engines associated with the respective search result.

20. The computer readable medium of claim 13, wherein the computer code instructions cause the computer to:
calculate a brand ownership score based on the classified search results; and
store the brand ownership score in a time series to allow for a trend analysis to be performed.
